(19) United States
(12) Patent Application Publication
(10) Pub. No.: US 2014/0164659 A1
(43) Pub. Date: Jun. 12, 2014

(54) REGULATING ACCESS TO SLAVE DEVICES

(71) Applicant: Wasim Quddus, Austin, TX (US)

(72) Inventor: Wasim Quddus, Austin, TX (US)

(21) Appl. No.: 13/706,911

(22) Filed: Dec. 6, 2012

(51) Int. Cl. G06F 13/364

(52) U.S. Cl. CPC G06F 13/364
USPC 710/110

(57) ABSTRACT

A method includes receiving a request from a master device to access a slave device of a plurality of slave devices that are associated with a slave port of bus switching fabric. The slave port is shared in common among the slave devices. The method includes, in response to the request, multiplexing use of the slave port among the slave devices.

### BACKGROUND

A computer system with multiple masters and slaves may include bus fabric for purposes of communicating data between initiating bus agents called “masters” (a processor, for example) and target bus agents, or “slaves” (memory devices, for example). In a typical bus operation, a master initiates a bus operation (such as a read or write operation) to a given slave by driving the address signals onto a bus to target the slave, along with the appropriate control signals and data signals (if data is being written to the slave). The slave that is the target of the bus operation responds by generating the appropriate signals onto the bus for such purposes as transferring data to or from the master; indicating an error; or signaling the master to retry the bus operation.

The bus is a limited system resource, which typically couples a single master to a single slave at any one time. Therefore, when multiple masters try to access the same slave at the same time, the bus matrix may time-multiplex their requests and may include a bus arbitration circuit, or “arbiter,” which performs arbitration among requesting masters to regulate which master (out of potentially multiple masters contending for bus access) has access to the bus.

### SUMMARY

In an example embodiment, a method includes receiving a request from a master device to access a slave device of a plurality of slave devices that are associated with a slave port of bus switching fabric. The slave port is shared among the slave devices. The method includes, in response to the request, multiplexing use of the slave port among the slave devices.

In another example embodiment, an apparatus includes a slave multiplexer; and bus matrix circuit that includes a slave port and a master port. The slave port is shared among a plurality of slave devices. The slave multiplexer is adapted to respond to a request initiated by a master coupled to the master port for access to a slave device of the slave devices to selectively couple the first slave device to the slave port.

In yet another example embodiment, an apparatus includes an integrated circuit that includes a processing core; a non-volatile memory device; a volatile memory device; a multiplexer; and a bus matrix circuit. The processing core is adapted to communicate with the non-volatile and volatile memory devices. The bus matrix circuit includes a slave port, and a master port that is coupled to the processing core. The multiplexer is adapted to selectively couple one of the non-volatile and volatile memory devices to the slave port in response to a request from the processing core to access the memory device.

Advantages and other desired features will become apparent from the following drawings, description and claims.

### BRIEF DESCRIPTION OF THE DRAWINGS

FIG. 1 is a schematic diagram of a system according to an example embodiment.

FIG. 2 is a schematic diagram of a microcontroller unit (MCU) according to an example embodiment.

FIG. 3 is a flow diagram depicting a technique to regulate access to slave devices of the MCU according to an example embodiment.

FIG. 4 is a schematic diagram of a motor control system according to an example implementation.

### DETAILED DESCRIPTION

A microcontroller unit (MCU) may include a processing core, which accesses machine executable instructions (“programs,” for example) that are stored in a non-volatile memory devices of the MCU, such as flash memory devices, for example. As a result of the program execution, the processing core may further access (i.e., write data to and read data from) program data, such as stacks, heaps, temporary variables, and so forth, which may be stored in volatile memory devices, such as static random access memories (SRAMs) of the MCU. Techniques and systems are disclosed herein, which permit a processing core to efficiently access program instructions and program data in a manner, which may be advantageous for purposes of minimizing or preventing arbitration cycles due to a processing core switching between non-volatile and volatile memory accesses.

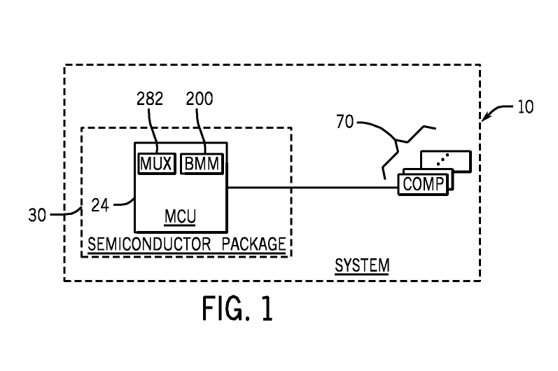

As a more specific example, FIG. 1 depicts an MCU 24 in an example system 10. For this example, the MCU 24 controls various aspects of one or multiple components 70. As examples, the components 70 may include one of more of the following depending on the particular application: an electrical motor, a household appliance, an inventory control terminal, a computer, a tablet, a smart power meter, a wireless interface, a cellular interface, an interactive touch screen user interface and so forth. All or part of the components of the MCU 24 may be part of an integrated circuit (IC), or semiconductor package 30. For example, all or part of the components of the MCU 24 may be fabricated on a single die or on multiple dies (a multi-chip module, for example) of the semiconductor package 30.

As discussed in further detail below, the MCU 24 includes a bus matrix circuit, or module 200, which regulates communications between master (a processing core, for example) and slaves (volatile and non-volatile memory devices, for example) of the MCU 24. A slave side multiplexer 282 of the MCU 24 is constructed to allow some of the slaves of the MCU 24 to share a port of the bus matrix module 200 in common, which, in turn, may provide the advantage of allowing a master, such as a processing core of the MCU 24, to incur few, if any, bus arbitration cycles, while switching between non-volatile and volatile memory accesses.

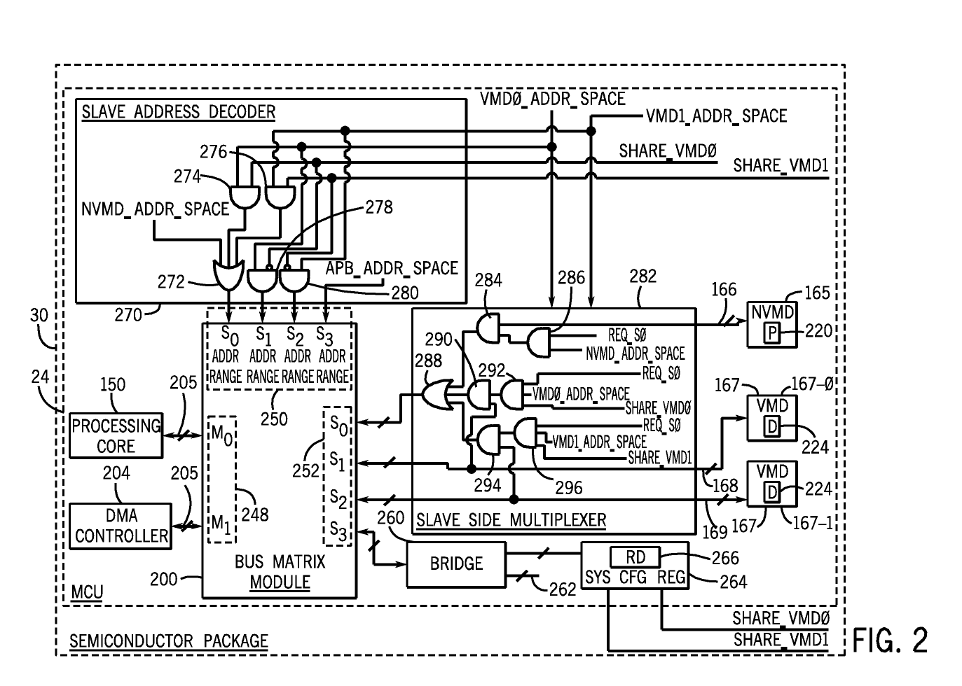

Referring to FIG. 2, in accordance with an example embodiment, the MCU 24 includes masters (or “master devices”), such as a processing core 150. As an example, in some embodiments, the processing core 150 may be a 32-bit core, such as the Advanced RISC Machine (ARM) processing core, which executes a Reduced Instruction Set Computer (RISC) instruction set. As disclosed herein, in general, the processing core 150 communicates with various other slaves (or “slave devices”) of the MCU 24, such as one or more non-volatile memory devices 165 (Flash memory devices, for example) and volatile memory devices 167 (static random access memory (SRAM) memory devices, for example). For the example that is described below, an exemplary non-volatile memory device 165 and two volatile memory devices 167-0 and 167-1 are depicted in FIG. 2, although it is understood that the MCU 24 may contain many other such devices, in accordance with other exemplary embodiments.

In accordance with an example embodiment disclosed herein, the non-volatile memory device 165 stores data 220 representing program instructions for execution by the processing core 150; and the volatile memory devices 167-0 and 167-1 store program data 224 that may be updated and read by the processing core 150 due to the execution of the program instructions. In this manner, the program data 224 may be associated with a stack, a heap, variables, arrays, and so forth. It is noted that the processing core 150 may read and write program instructions data and program data to other volatile and non-volatile memory devices of the MCU 24.

It is noted that the MCU 24 may contain masters and slaves other than the ones depicted in FIG. 2, depending on the particular embodiment. For example, the slaves may include components other than memory storage components, such as, as examples, a math accelerator, components that receive analog signals, such as analog-to-digital converters (ADCs), comparators, etc. from the environment external to the MCU 24 and digital components, such as, as examples, a Universal Serial Bus (USB) interface, a universal asynchronous receiver/transmitter (UART), a system management bus (SMB) interface, a serial peripheral (SPI) interface, and so forth.

The MCU 24 includes a bus switching matrix, or bus switching fabric, which is generally referred to as the “bus matrix circuit” or “bus matrix module 200” herein. In an example embodiment, the bus matrix module 200 may be an integrated circuit (fabricated on a single die or on multiple dies, for example); and in further embodiments, the bus matrix module 200 may be a set of integrated circuits. The bus matrix module 200 regulates communications between a set of masters and a set of slaves of the MCU 24. For the example embodiment of FIG. 2, the bus matrix module 200 contains master ports 248 (specific master ports M₀ and M₁ being depicted in FIG. 2) that are coupled to such masters as the processing core 150 and a direct memory access (DMA) controller 204. In this manner, each master communicates address, control and data signals 205 with a corresponding master port 248, such as the address, control and data signals 205 for the processing core 150, which are coupled to the M₀ port in FIG. 2. A given master may have multiple bus ports. In such a case, each bus port may couple to individual master ports of the bus matrix module 200. The master ports of the master 248 may also be multiplexed and then coupled to bus matrix master ports.

The bus matrix module 200 further contains slave ports 252 (specific slave ports S₀, S₁, S₂ and S₃ being depicted in FIG. 2), which are selectively coupled to address, control and data signals of slaves, such as the non-volatile 165 and volatile 167 memory devices, as further discussed herein. In this manner, the bus matrix module 200 generally contains such circuitry as switches (transistors, for example) that controlled by the module 200 to selectively coupled the address, control and data signals of slaves and masters together. Depending on the particular embodiment, the bus matrix module 200 may be entirely formed from hardware components or may be formed from a combination of hardware and software.

A given master, such as the processing core 150, may request access to one of the slaves, and provide a corresponding address to the bus matrix module 200 to select one of the slave ports 252 so that the bus matrix module 200 couples a slave that is associated with the selected slave port to the master. In accordance with an example embodiment, indications of the slave ports selected by the masters appear as corresponding signals at corresponding slave selection ports 250 of the bus matrix module 200. These indications may be, for example, derived from decoded address bits, so that a particular address space may be identifiable with a given slave port (and associated slave). Because multiple masters may attempt to concurrently access the same slave port, the bus matrix module 200, in accordance with an example embodiment, performs a time-multiplexed arbitration (a fairness-based policy, such as a round robin-based policy, a priority-based policy or a policy that takes into account a combination of fairness and priority, as examples) among multiple masters that are requesting the same slave port. In other words, the arbitration-controlled access to the slaves accommodates the scenario in which multiple masters are concurrently contending for access to a given slave. Due to the ability of the bus matrix module 200 to form multiple, concurrent master-slave connections, concurrent, or parallel, accesses are allowed between pairs of masters and slaves, in accordance with example embodiments.

In accordance with systems and techniques that are disclosed herein, the MCU 24 allows multiple slaves to be accessed using a single slave port 252 of the bus matrix module 200, which is shared in common among these slaves. Such an arrangement has the particular advantage of decreasing latency that may otherwise be incurred as the processing core 150 switches access from one slave port to another if the accessed slaves were, for example, assigned to individual slave ports. For the example embodiment that is described herein, the MCU 24 executes program instructions, which are stored as program instruction data 220 in the non-volatile memory device 165; and the MCU 24 processes program data 224 that resides in the volatile memory devices 167-0 and 167-1. The multiplexing of the slave devices onto a single slave port 252 has the particular advantage of preventing the bus matrix module 200 from stalling for one or multiple cycles as a given master switches from one slave to the next. In accordance with the systems and techniques that are disclosed herein, the address decoding scheme combines the multiple slave address ranges to the address range of the slave port 252, which the slaves share due to the slave port multiplexing. When programmed this way, the bus matrix module 200 perceives a given master as switching between slaves, although such switching may be occurring, thereby avoiding “stalling” the bus matrix module 200. It is noted that the slave side multiplexer 282 contains additional decode logic not depicted in FIG. 2 to couple the appropriate slave bus to the single slave port of 252, as the diagram of the slave side multiplexer 282 in FIG. 2 illustrates features pertaining to the slave port multiplexing.

As the processing core 150 executes a particular program or application, the processing core 150 may access both non-volatile memory devices, such as the non-volatile device 165 depicted in FIG. 2, as well as volatile memory devices 167, such as the volatile memory devices 167-0 and 167-1, for purposes of retrieving program instructions and storing and retrieving the associated program data without incurring any bus matrix arbitration penalty, in accordance with example implementations. These accesses, in turn, involve communications over a single bus.

More specifically, in accordance with an example embodiment, the MCU 24 may employ a “von Neumann”-type architecture, which means that the MCU 24 communicates signals representing both program instructions and data using a single bus. With such an architecture, the processing core 150 uses time-multiplexed bus operations (read cycles, write cycles, and so forth) on the bus to access the non-volatile memory devices 165 and volatile memory devices 167. Because each program instruction may include both instruction fetching and data fetching, the slave device multiplexing technique disclosed herein has the particular advantage of generally avoiding consuming bus cycles due to the data and instruction fetching, as can be appreciated by the skilled artisan.

In accordance with example embodiments, the MCU 24 includes a slave address decoder 270 and the slave side multiplexer 282. In general, the slave address decoder 270 is coupled to slave selection ports 250 (example slave selection ports S₀, S₁, S₂ and S₃ being depicted in FIG. 2) to allow multiple address ranges (associated with multiple slaves) to share a slave port 252 of the bus matrix module 200 in common. In this regard, any of these multiple address ranges may be used to select the slave port 252 that is shared in common. As a more specific example, the non-volatile memory device 165, volatile memory device 167-0, and volatile memory device 167-1 may be addressed using three different address ranges; and for this example, these slaves may share the S₀ slave port 252. The slave address decoder 270 is constructed to respond to a master's request for access to any one of these three different address ranges by selecting the S₀ slave port.

In general, the slave side multiplexer 282 controls the coupling of the slaves to the slave ports 252 and the multiplexing of multiple slaves with a slave port that is shared in common. For the example embodiment of FIG. 2, the slave side multiplexer 282 multiplexes the use of the S₀ slave port 252 among the non-volatile memory device 165, the volatile memory device 167-0 and the volatile memory device 167-1. Moreover, for the example embodiment that is depicted in FIG. 2, the slave side multiplexer 282 allows the volatile memory devices 167-0 and 167-1 to be solely assigned to the S₁ and S₂ slave ports 252, respectively (and not be shared with the S₀ slave port 252), as configured by register data 266 of a system configuration register 264 that is coupled (via a bridge 260) to the S₃ slave port 252. Thus, many variations and embodiments are contemplated, which are within the scope of the appended claims.

More specifically, in accordance with an example embodiment, the register data 266 may be programmable by the processing core 150 and contain respective bits that have associated logic levels that may be used to selectively program slave port assignments. For the example embodiment described herein, the register data 266 controls at least which slaves share the S₀ slave port 252, with given bits of the register data 266 individually corresponding to the slaves. For the example embodiment of FIG. 2, the register data 266 contains two bits that individually control whether the volatile memory devices 167-0 and 167-1 share the S₀ slave port 252; and these two bits are represented by two respective signals: a SHARE_VMD0 signal that is asserted (driven to a logic one value, for example) to configure the volatile memory device 167-0 to share the S₀ slave port 252 (in lieu of being assigned the S₁ slave port 252 with the non-volatile memory device 165 (and potentially with the volatile memory device 167-1, depending on its assignment), and a SHARE_VMD1 signal that is asserted (driven to a logic one value, for example) to configure the volatile memory device 167-1 to share the S₀ slave port 252 (in lieu of being assigned to the S₂ slave port 252) with the non-volatile memory device 165 (and potentially with the volatile memory device 167-0, depending on its assignment).

Turning now to an example embodiment for the slave address decoder 270, in accordance with some embodiments, the slave address decoder 270 controls the selective assertion of the slave request ports 250 of the bus matrix module 200 based on address space signals: an NVMD_ADDR_SPACE signal that is asserted (driven to a logic one value, for example) to indicate a master access that targets an address within the address space of the non-volatile memory device 165; an APB_ADDR_SPACE signal that is asserted (driven to a logic one value, for example) to indicate a master access that targets the address of the system configuration register 264; an VMD0_ADDR_SPACE signal that is asserted (driven to a logic one value, for example) to indicate a master access that targets an address within the address space of the volatile memory device 167-0; and an VMD1_ADDR_SPACE signal that is asserted (driven to a logic one value, for example) to indicate a master access that targets an address within the address space of the volatile memory device 167-1. These signals may be decoded address line signals, as an example.

In general, the slave address decoder 270 responds to the SHARE_VMD0 and SHARE_VMD01 signals such that these signals may be used to selectively effectively map the address ranges of the volatile memory devices 167-0 and 167-1 to the address range of the non-volatile memory device 165 for purposes of slave port selection.

More specifically, in accordance with an example embodiment, the slave address decoder 270 includes an OR gate 272 that has its output signal coupled to the S₀ slave selection port 250. The OR gate 272 receives the NVMD_ADDR_SPACE signal and a signal that is provided by the output terminal of an AND gate 274 that receives the VMD0_ADDR_SPACE signal and the SHARE_VMD0 signal. The OR gate 272 also receives an output signal that is provided by an AND gate 276 that receives the VMD1_ADDR_SPACE signal and the SHARE_VMD1 signal. Thus, the OR gate 272 asserts (drives to a logic one value, for example) the S₀ selection port to thereby select the S₀ slave port 252 in response to either a master request that targets the address space of the non-volatile memory device 165, a master request that targets the address space of the volatile memory device 167-0 (assuming the volatile memory device 167-0 is configured to share the S₀ slave port 252), or a master request that targets the address space of the volatile memory device 167-1 (assuming the volatile memory device 167-1 is configured to share the S₀ slave port 252).

The slave address decoder 270 further includes an AND gate 278 that has its output signal coupled to the S₁ slave selection port 250. The AND gate 278 receives the VMD0_ADDR_SPACE signal and the inverted SHARE_VMD0 signal. Thus, the AND gate 278 asserts (drives to a logic one value, for example) the S₁ selection port to thereby select the S₁ slave port 252 in response to a master request targeting the address space of the volatile memory device 167-0 and the volatile memory device 167-0 being assigned to the S₁ slave port 252 instead of sharing the S₀ slave port 252.

The slave address decoder 270 also includes an AND gate 280 that has its output signal coupled to the S₂ slave selection port 250. The AND gate 280 receives the VMD1_ADDR_SPACE signal and the inverted SHARE_VMD1 signal. Thus, the AND gate 280 asserts (drives to a logic one value, for example) the S₂ selection port to thereby select the S₂ slave port 252 in response to a master request targeting the address space of the volatile memory device 167-1 and the volatile memory device 167-1 being assigned to the S₂ slave port 252 instead of sharing the S₀ slave port 252. Lastly, for the embodiment depicted in FIG. 2, the slave address decoder 270 provides the APB_ADDR_SPACE signal to the S₃ slave selection port 250, as the system configuration register 264 for this example is dedicated to the S₃ slave port 252 so that the S₃ slave port 252 is selected in response to a master request targeting the address of the system configuration register 264.

In accordance with an example embodiment, the slave side multiplexer 282 selectively couple slaves (such as the non-volatile memory device 165, the volatile memory device 167-0 and the volatile memory device 167-1) to the slave ports 252. The slave side multiplexer 282 includes an OR gate 288 that has multiple output terminals that provide the address, control and data signals for a selected slave device to the S₀ slave port 252. More specifically, the OR gate 288 includes a first set of input terminals that receive gated address, control and data signals 166 from the non-volatile memory device 165. These gated signals are provided by the multiple output terminals of an AND gate 284. The AND gate 284 includes a set of input terminals coupled to the signals 166 and an input terminal that is coupled to the output terminal of an AND gate 286 to control the gating, i.e., control when the signals 166 are coupled to the S₀ slave port 252. The AND gate 286 receives a signal called “REQ_S0,” which is asserted when a master requests one of the slave devices associated with the S₀ slave port 252 and the arbiter of the bus matrix module 200 granting the access. The AND gate 286 also receives the NVMD_ADDR_SPACE signal, which is asserted (driven to a logic one value, for example) when the master is requesting the address space associated with the non-volatile memory device 165.

The OR gate 288 includes a second set of input terminals that receive gated address, control and data signals 168 from the volatile memory device 167-0. These gated signals are provided by the multiple output terminals of an AND gate 290. The AND gate 290 includes a set of input terminals coupled to the signals 168 and an input terminal that is coupled to the output terminal of an AND gate 292 to control the gating. The AND gate 292 receives the REQ_S0 signal and receives signal “VMD0_ADDR_SPACE,” which is asserted (driven to a logic one value, for example) when the master is requesting the address space associated with the volatile memory device 167-0. The AND gate 292 also receives the SHARE_VMD0 signal. Therefore, the AND gate 290 couples the signals 168 from the volatile memory device 167-0 to the OR gate 288 (and to the S₀ slave port 252) when a master requests access to the volatile memory device 167-0, the access is granted and the MCU 24 is configured (via the system configuration register 264) to share the S₀ slave port 252 with the volatile memory device 167-0.

The OR gate 288 includes a third set of input terminals that receive gated address, control and data signals 169 from the volatile memory device 167-1. These gated signals are provided by the multiple output terminals of an AND gate 294. The AND gate 294 includes a set of input terminals coupled to the signals 169 and another include input terminal that is coupled to the output terminal of an AND gate 296 to control the gating. The AND gate 296 receives the REQ_S0 signal and receives signal “VMD1_ADDR_SPACE” which is asserted (driven to a logic one value, for example) when the master is requesting the address space associated with the volatile memory device 167-1. The AND gate 296 also receives the SHARE_VMD1 signal. Therefore, the AND gate 294 couples the signals 169 from the volatile memory device 167-1 to the OR gate 288 (and to the S₀ slave port 252) when a master requests access to the volatile memory device 167-1, the access is granted and the MCU 24 is configured (via the system configuration register 264) to share the S₀ slave port 252 with the volatile memory device 167-1.

As depicted in FIG. 2, in accordance with an example embodiment, the signals 168 of the volatile memory device 167-0 may be coupled to the S1 slave port 252 so that the volatile memory device 167-0 may be accessed using an address range that is assigned to the S1 slave port 252. Similarly, the signals 169 of the volatile memory device 167-1 may be coupled to the S₂ slave port 252 so that the volatile memory device 167-1 may be accessed using an address range that is assigned to the S₂ slave port 252. Moreover, as depicted in FIG. 2, in accordance with an example embodiment, the bridge 260 may be coupled to the S₃ slave port 252. In addition to the system configuration register 264, other devices (input devices and so forth) may be coupled to terminals 262 of the bridge 260 and may be accessible though the S₃ slave port 252.

Other variations are contemplated, which are within the scope of the appended claims. For example, in accordance with a further embodiment, two slaves may share the S₀ slave port 252 and not have an alternate path to the S₁ slave port 252. As a more specific example, in accordance with a particular embodiment, the non-volatile memory device 165 and a math accelerator slave device may both share the S₀ slave port 252 (with one or more volatile memory devices 167, for example), and the non-volatile memory device 165 and math accelerator device may not have alternative paths to another slave port 252. Such an arrangement may have the advantage of eliminating an arbitration cycle as a master transitions from the non-volatile memory device 165 to the math accelerator and back.

As another example, in accordance with further embodiments, two slaves may share the S₁ slave port. For example, in accordance with an example embodiment, the volatile memory devices 167-0 and 167-1 may share the S₁ slave port 252 using multiplexing circuitry of the slave side multiplexer 282. This embodiment has the advantage of combining the two volatile memory devices 167-0 and 167-1 so that the devices 167-0 and 167-1 behave like a single memory device (a single SRAM device, for example), thereby reducing arbitration latency as master accesses transition between their address ranges.

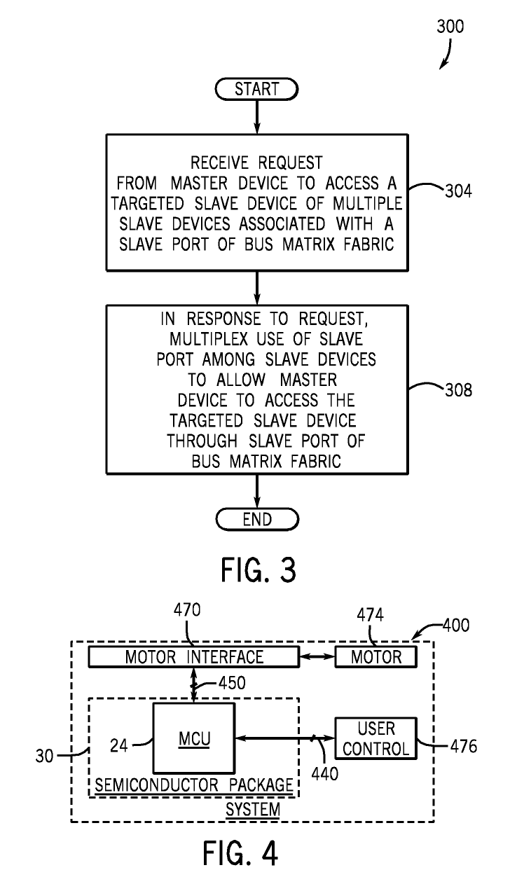

Referring to FIG. 3, thus, pursuant to an example embodiment, a method 300 includes receiving (block 304) a request from a master to access a targeted slave device of multiple slave devices that are associated with a slave port of the bus switching fabric. Pursuant to the method 300, in response to the request, the use of the slave port by the slave devices is multiplexed (block 308) among the slave devices to allow the master to access the targeted slave device.

Referring to FIG. 4, the MCU 24 may be used in numerous different applications. As an example, FIG. 4 depicts a motor control application in which an MCU 24 of a motor control system 400 generates/receives input and output signals (I/O signals) for purposes of controlling a motor 474. In this manner, the MCU 24 may generate signals at its I/O terminals 450 for purposes of communicating with a motor interface 470 (an interface containing drivers, sensors, and so forth); and in connection with this communication, the I/O terminals 450 may communicate waveforms with the motor interface (pulse width modulation (PWM) signals, for example), receive sensed currents and voltages, communicate data via one or more serial buses, and so forth. I/O terminals 440 of the MCU 24 may generate/receive signals to communicate with a user control interface 476 of the system 400 for such purposes as communicating status of the motor 474 or motor interface 470, communicating detected fault conditions, receiving user-directed commands and signals, and so forth.

While a limited number of embodiments have been disclosed herein, those skilled in the art, having the benefit of this disclosure, will appreciate numerous modifications and variations therefrom. It is intended that the appended claims cover all such modifications and variations.

What is claimed is:

1. A method comprising:
receiving a request from a master device targeting a slave device of a plurality of slave devices associated with a slave port of bus switching fabric, the slave port being shared among the plurality of slave devices; and
in response to the request, multiplexing use of the slave port among the plurality of slave devices.

2. The method of claim 1, wherein the request indicates an address associated with the targeted slave device, and multiplexing use of the slave port comprises selecting the targeted slave device based on the address.

3. The method of claim 1, further comprising using the bus switching fabric to selectively couple the master port to the slave port based on an arbitration protocol that takes into account whether at least one other master is concurrently contending for access to at least one slave device of the plurality of slave devices.

4. The method of claim 1, further comprising:
communicating program instructions and program data between the master device and the plurality of slave devices coupled to the slave port.

5. The method of claim 1, wherein receiving the request comprises decoding an address provided by the master device.

6. The method of claim 1, wherein multiplexing use of the slave port comprises multiplexing use of the slave port among at least a non-volatile memory device and a volatile memory device.

7. The method of claim 1, further comprising:
using a register to program register data to identify the plurality of slave devices sharing the slave port.

8. An apparatus comprising:
a bus matrix circuit comprising a slave port and a master port, the slave port being shared among a plurality of slave devices; and
a multiplexer adapted to respond to a request initiated by a master coupled to the master port for access to a first slave device of the plurality of slave devices to selectively couple the first slave device to the slave port.

9. The apparatus of claim 8, wherein the slave devices comprise at least one volatile memory device and at least one non-volatile memory device.

10. The apparatus of claim 8, further comprising:
a slave address decoder to indicate selection of the slave port in response to a plurality of address ranges associated with the plurality of slave devices.

11. The apparatus of claim 8, wherein the multiplexer is adapted to selectively couple the plurality of slave devices to the slave port.

12. The apparatus of claim 8, further comprising a register coupled to the bus matrix circuit to store data, the register adapted to programmably configure sharing of the slave port among the plurality of slave devices.

13. An apparatus comprising:
an integrated circuit comprising a processing core, a non-volatile memory device, a volatile memory device, a multiplexer and a bus matrix circuit, wherein:
the processing core is adapted to communicate with the non-volatile and volatile memory devices;
the bus matrix circuit comprises a slave port and a master port that is coupled to the processing core; and
the multiplexer is adapted to selectively couple one of the non-volatile and the volatile memory devices to the slave port in response to a request from the processing core to access the one of the non-volatile and volatile memory devices.

14. The apparatus of claim 13, wherein:
the bus matrix circuit is adapted to selectively couple the master port to the slave port; and
the bus matrix circuit is adapted to control the coupling based at least in part on application of an arbitration protocol.

15. The apparatus of claim 13, further comprising a register coupled to the bus matrix circuit, the register adapted to store data to programmably configure sharing of the slave port among the plurality of slave devices.

16. The apparatus of claim 15, wherein the processor core is adapted to communicate a request to the bus matrix circuit for access to the slave port, the request indicates an address associated with the slave port, and the multiplexer is adapted to select the non-volatile or volatile memory device associated with the address to service the request.

17. The apparatus of claim 13, wherein the bus matrix circuit is adapted to cause the processing core to perceive the non-volatile and volatile memory devices as collectively being a unitary slave device.

18. The apparatus of claim 13, wherein the bus matrix circuit further comprises at least one additional master port, the apparatus further comprising a direct memory access controller coupled to the at least one additional master port.

19. The apparatus of claim 13, wherein the integrated circuit further comprises a non-memory storage-based slave device to share the slave port.

20. The apparatus of claim 13, further comprising a bus to couple the processing core to the bus matrix circuit.
